(19) United States
(12) Patent Application Publication
(10) Pub. No.: US 2016/0344918 A1
(43) Pub. Date: Nov. 24, 2016

(54) MOBILE REVERSE VIDEO CAPTURE AND DISPLAY SYSTEM

(71) Applicant: Kiet Q. Tao, Anaheim, CA (US)

(72) Inventor: Kiet Q. Tao, Anaheim, CA (US)

(21) Appl. No.: 14/718,325

(22) Filed: May 21, 2015

(51) Int. Cl. H04N 5/232

(52) U.S. Cl. CPC H04N 5/23206; H04N 5/23293

(57) ABSTRACT

A wearable reverse-video capture and display system includes a magnetic holder removably secured to an object worn by a wearer, which magnetically connects to a video capture device having a ferrous base. The video capture device utilizes a communication link to transmit the video signal and a video display device, worn by the wearer, displays in real time scenes residing in the wearer's rear view on a display screen included in the video display device. The video capture device may include a night vision device and the video display device may include an alarm button and an emergency assistance button (SOS).

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to mobile reverse video capture and display system. In particular, the present invention relates to a system and method for capturing and displaying, in real time, reverse-video of scenes residing in the wearer's rear view on a video display device. In an alternative embodiment, the video capture device further comprises a night vision device configured to capture the reverse-video of scenes in darkness. In another alternative embodiment, the video display device further includes an emergency assistance button (SOS) to transmit emergency signal upon activation of the button and/or alarm button to sound an alarm upon activation of the button.

### BACKGROUND

The present invention seeks to provide a wearable reverse-video capture and display system including method of operation and user interface, whereby the wearer can view scenes from behind the wearer on a display screen included in a video display device in real time for security and other uses such as ocean scuba diving. The system includes a magnetic holder that is secured to an object that is worn by the wearer, such as the wearer's shirt, eyeglasses, or backpack. A video capture device with a ferrous base is magnetically coupled with the holder and operates to capture and transmit the reverse-video utilizing a communication link. The video display device, worn by the wearer, receives the reverse-video using the communication link and displays, on its display screen, scenes that are behind the wearer in real time. In a preferred embodiment of the present invention, the video capture device further comprises a night vision device which is configured to capture the reverse-video of scenes in darkness. In another preferred embodiment, the video display device further includes an emergency assistance button (SOS) which the wearer can activate to transmit an emergency signal via the communication link. In another preferred embodiment, the video display device further comprises an alarm button, which the wearer can activate to sound an alarm. In another preferred embodiment, the wearer can record the reverse-video in a storage device included in the video capture device.

Body worn video (BWV), also known as body cameras, is a video recording system that is typically utilized by law enforcement to record their interactions with the public, gather video evidence at crime scenes, and has been known to increase both officer and citizen accountability. BWVs are notable because their placement, often on the front of a shirt, provides for first-person perspective and a more complete chain of evidence. BWV is a form of closed-circuit television.

Closed-circuit television (CCTV), also known as video surveillance, is the use of video cameras to transmit a signal to a specific place, on a limited set of monitors. It differs from broadcast television in that the signal is not openly transmitted, though it may employ point to point (P2P), point to multipoint, or mesh wireless links. Though almost all video cameras fit this definition, the term is most often applied to those used for surveillance in areas that may need monitoring such as banks, casinos, airports, military installations, and convenience stores.

A video camera is a camera used for electronic motion picture acquisition (as opposed to a movie camera, that earlier recorded the images on film), initially developed for the television industry but now common in other applications as well.

All-electronic designs based on the video camera tube remained in wide use until the 1980s, when cameras based on solid-state image sensors such as CCDs (and later CMOS active pixel sensors) eliminated common problems with tube technologies such as image burn-in and made digital video workflow practical. The transition to digital TV gave boost to digital video cameras and by 2010s, most of the video cameras were digital video cameras.

With the advent of digital video capture, the distinction between professional video cameras and movie cameras have disappeared as the intermittent mechanism has become the same. Nowadays, mid-range cameras exclusively used for television and other works (except movies) are termed as professional video cameras.

Video cameras are used primarily in two modes. The first, characteristic of much early broadcasting, is live television, where the camera feeds real time images directly to a screen for immediate observation. A few cameras still serve live television production, but most live connections are for security, military/tactical, and industrial operations where surreptitious or remote viewing is required. In the second mode the images are recorded to a storage device for archiving or further processing; for many years, videotape was the primary format used for this purpose, but gradually supplanted by optical disc, hard disk, and finally flash memory. Recorded video is used in television production, and more often surveillance and monitoring tasks where unattended recording of a situation is required for later analysis.

Modern video cameras have numerous designs and uses. Professional video cameras, such as those used in television production. These may be television studio-based or mobile in the case of an electronic field production (EFP). Such cameras generally offer extremely fine-grained manual control for the camera operator, often to the exclusion of automated operation. Usually uses 3 sensors to record separate of Red, Green and Blue. Camcorders, which combine a camera and a VCR or other recording device in one unit. These are mobile, and were widely used for television production, home movies, electronic news gathering (ENG) (including citizen journalism), and similar applications. Since the transition to digital video cameras, most of the cameras have in-built recording media and as such are also camcorders. Closed-circuit television (CCTV) generally use pan tilt zoom cameras (PTZ), for security, surveillance, and/or monitoring purposes. Such cameras are designed to be small, easily hidden, and able to operate unattended. Those used in industrial or scientific settings are often meant for use in environments that are normally inaccessible or uncomfortable for humans, and are therefore hardened for such hostile environments (e.g. radiation, high heat, or toxic chemical exposure). Webcams are video cameras which stream a live video feed to a computer. Camera Phones, nowadays most video cameras are incorporated in mobile phones. Special camera systems, like those used for scientific research, e.g. on board a satellite or a spaceprobe, in artificial intelligence and robotics research, in medical use. Such cameras are often tuned for non-visible radiation for Infrared (for night vision and heat sensing) or X-ray (for medical and video astronomy use).

A webcam is a video camera that feeds or streams its image in real time to or through a computer to computer network. When captured by the computer, the video stream may be saved, viewed or sent on to other networks via systems such as the internet, and email as an attachment. When sent to a remote location, the video stream may be saved, viewed or on sent there. Unlike an IP camera (which connects using Ethernet or Wi-Fi), a webcam is generally connected by a USB cable, or similar cable, or built into computer hardware, such as laptops. The term webcam (a clipped compound) may also be used in its original sense of a video camera connected to the Web continuously for an indefinite time, rather than for a particular session, generally supplying a view for anyone who visits its web page over the Internet. Some of them, for example, those used as online traffic cameras, are expensive, rugged professional video cameras.

Webcams typically include a lens, an image sensor, support electronics, and may also include a microphone for sound. Various lenses are available, the most common in consumer-grade webcams being a plastic lens that can be screwed in and out to focus the camera. Fixed focus lenses, which have no provision for adjustment, are also available. As a camera system's depth of field is greater for small image formats and is greater for lenses with a large f-number (small aperture), the systems used in webcams have a sufficiently large depth of field that the use of a fixed focus lens does not impact image sharpness to a great extent.

Image sensors can be CMOS or CCD, the former being dominant for low-cost cameras, but CCD cameras do not necessarily outperform CMOS-based cameras in the low cost price range. Most consumer webcams are capable of providing VGA resolution video at a frame rate of 30 frames per second. Many newer devices can produce video in multi-megapixel resolutions, and a few can run at high frame rates such as the PlayStation Eye, which can produce 320×240 video at 120 frames per second.

Support electronics read the image from the sensor and transmit it to the host computer. The camera pictured to the right, for example, uses a Sonix SN9C101 to transmit its image over USB. Typically, each frame is transmitted uncompressed in RGB or YUV or compressed as JPEG. Some cameras, such as mobile phone cameras, use a CMOS sensor with supporting electronics “on die”, i.e. the sensor and the support electronics are built on a single silicon chip to save space and manufacturing costs. Most webcams feature built-in microphones to make video calling and videoconferencing more convenient.

An Internet protocol camera, or IP camera, is a type of digital video camera commonly employed for surveillance, and which, unlike analog closed circuit television (CCTV) cameras, can send and receive data via a computer network and the Internet. Although most cameras that do this are webcams, the term “IP camera” or “netcam” is usually applied only to those used for surveillance. The first centralized IP camera was Axis Neteye 200, released in 1996 by Axis Communications. There are two kinds of IP cameras. Centralized IP cameras require a central Network Video Recorder (NVR) to handle the recording, video and alarm management. Decentralized IP cameras do not require a central Network Video Recorder (NVR), as the cameras have recording function built-in and can thus record directly to any standard storage media, such as SD cards, NAS (network attached storage) or a PC/Server.

A smartwatch, such as the Apple Watch manufactured by the Apple Company, is a computerized wristwatch with functionality that is enhanced beyond timekeeping. While early models can perform basic tasks, such as calculations, translations, and game-playing, modern smartwatches are effectively wearable computers. Many smartwatches run mobile apps, while a smaller number of models run a mobile operating system and function as portable media players, offering playback of FM radio, audio, and video files to the user via a Bluetooth headset. Some smartwatches models, also called “watch phones”, feature full mobile phone capability, and can make or answer phone calls.

Such devices may include features such as a camera, accelerometer, thermometer, altimeter, barometer, compass, chronograph, calculator, cell phone, touch screen, GPS navigation, Map display, graphical display, speaker, scheduler, watch, SDcards that are recognized as a mass storage device by a computer, and rechargeable battery. It may communicate with a wireless headset, heads-up display, insulin pump, microphone, modem, or other devices.

Some also have “sport watch” functionality with activity tracker features (also known as “fitness tracker”) as seen in GPS watches made for Training, Diving, and Outdoor sports. Functions may include training programs (such as intervals), Lap times, speed display, GPS tracking unit, Route tracking, dive computer, heart rate monitor compatibility, Cadence sensor compatibility, and compatibility with sport transitions (as in triathlons).

Like other computers, a smartwatch may collect information from internal or external sensors. It may control, or retrieve data from, other instruments or computers. It may support wireless technologies like Bluetooth, Wi-Fi, and GPS. However, it is possible a “wristwatch computer” may just serve as a front end for a remote system, as in the case of watches utilizing cellular technology or Wi-Fi.

A night vision device (NVD) is an optoelectronic device that allows images to be produced in levels of light approaching total darkness. The image may be a conversion to visible light of both visible light and near-infrared, while by convention detection of thermal infrared is denoted thermal imaging. The image produced is typically monochrome, e.g. shades of green. NVDs are most often used by the military and law enforcement agencies, but are available to civilian users. The term usually refers to a complete unit, including an image intensifier tube, a protective and generally water-resistant housing, and some type of mounting system. Many NVDs also include optical components such as a sacrificial lens, or telescopic lenses or mirrors. An NVD may have an IR illuminator, making it an active as opposed to passive night vision device. Night vision devices were first used in World War II, and came into wide use during the Vietnam War. The technology has evolved greatly since their introduction, leading to several “generations” of night vision equipment with performance increasing and price decreasing. Consequently they are available for a wide range of applications, e.g. for gunners, drivers and aviators. Another term is “night optical/observation device” or NOD.

An emergency assistance button (SOS) is included in the well-known Safety Connect technology which is a subscription-based telematics system. The system provides communications, roadside assistance, car safety, remote diagnostics, and other services. The SOS button can be used to contact rescue services. A 24-hour call center with law enforcement linkage also can track the location of the device via the Safety Connect GPS signal.

Although various systems have been proposed which touch upon some aspects of the above problems, they do not provide solutions to the existing limitations in providing a wearable reverse-video capture and display system. For example, Gorischek, U.S. Pat. App. No. 20050264543 entitled “Video Backpack and Garment System and Method Of Using the Same” discloses an image display system, comprising a wearable gear, such as a backpack or garment, with an integrated electronic display screen, at least one video image source capable of providing an image on the display screen, and a control unit. The control unit controls the video image source to transmit to the display screen signals that are representative of the image. The backpack and garment may be used as functional items for entertaining, informing, or educating a viewer via images displayed on the display screen. The backpack and garment may also be used as novelty items by controlling the images displayed on the display screen and changing the appearance of the backpack and garment. The backpack and garment may further act as a marketeering tool for displaying advertisement messages.

Buskop, U.S. Pat. No. 7,598,928 entitled “Video Display Hat” discloses a hat for a displaying video signals having, a hat, a fuel cell operated video display mounted as an integral structural component of the hat, a fuel cell operated video camera having a blue tooth wireless connection to the video display and removably mounted to the hat, and wherein the video camera captures images in the direction of an indication of the hat.

Donato, U.S. Pat. No. 8,063,934 entitled “Helmet for Displaying Environmental Images in Critical Environments” discloses a helmet for displaying environmental images in critical environments, comprising at least one video camera and a display for displaying environmental images, the helmet also has a supporting structure that can be anchored to the helmet in order to support the at least one video camera and the display, the supporting structure has a front adapter that can be coupled to a front edge of the helmet, a rear adapter that can be coupled to a rear edge of the helmet, and a connecting element for mutually connecting the front adapter and the rear adapter.

Ennis, U.S. Pat. No. 8,692,886 entitled “Multidirectional Video Capture Assembly” discloses a multidirectional video capture assembly that can include a multidirectional helmet camera with protective housing and plurality of image sensors. The image sensors may be oriented in a plurality of directions for simultaneous capture of image data. A multi channel flexible cable can emerge from said protective housing, said cable adapted to carry image signals from the image sensors to an image recording and/or image display device. The protective housing may also be equipped with a complimentary equipment cavity for inclusion of additional advantageous equipment, as may be included to suit individual circumstances. However, none of the above references provide a wearable reverse-video capture and display system having the above mentioned features available in the present invention.

### SUMMARY

In one aspect, a wearable reverse-video capture and display system worn by a wearer moving in a first direction is disclosed wherein the system comprises a magnetic holder removably secured to an object worn by the wearer, the holder having a coupling plane whose normal vector is in a second direction substantially opposite to the first direction, a video capture device including a ferrous base magnetically secured to the coupling plane of the holder, via magnetic flux, configured to capture the reverse-video of scenes in the second direction and transmit the reverse-video, via a communication link, and a video display device, configured to receive the reverse-video, via the communication link and display the reverse-video on a display screen included in the video display device, wherein the wearer views the scenes residing in the wearer's rear view on the video display device in real time.

Preferably, the magnetic holder is disposed on a first side of the object and the video capture device is disposed on a second side of the object opposite to the first side. Preferably, the object comprises a pocket and wherein the magnetic holder is disposed inside the pocket and on a first side of the pocket and the video capture device is disposed on a second side of the pocket opposite to the first side. Preferably, the magnetic holder is embedded in the object. Preferably, the object is one of a garment, eye glasses, and backpack. Preferably, the magnetic holder comprises a fastener operative to fasten the magnetic holder to the object. Preferably, the fastener is one of adhesive tape and an alligator clip. Preferably, the video capture device further comprises a night vision device configured to capture the reverse-video of scenes in darkness. Preferably, the video display device further comprises an emergency assistance button (SOS) and wherein the video display device is further configured to transmit an emergency signal, via the communication link, upon activation of the button. Preferably, the video display device further comprises an alarm button and wherein the video display device is further configured to sound an alarm upon activation of the button. Preferably, the video display device is one of a smartwatch and smartphone. Preferably, the communication link comprises at least one of Bluetooth, WiFi, and the Internet. Preferably, the video capture device is further configured to record the reverse-video in a storage device included in the video capture device.

In another aspect, a method of capturing and displaying reverse-video via a wearable reverse-video capture and display system worn by a wearer moving in a first direction is disclosed wherein the method comprises removably securing a magnetic holder to an object worn by the wearer, the holder having a coupling plane whose normal vector is in a second direction substantially opposite to the first direction, capturing the reverse-video of scenes in the second direction, via a video capture device including a ferrous base magnetically secured to the coupling plane of the holder, via magnetic flux, transmitting the reverse-video, via a communication link, receiving the reverse-video, via the communication link, and displaying the reverse-video on a display screen, via a video display device including the display screen, wherein the wearer views the scenes residing in the wearer's rear view on the video display device in real time.

Preferably, the method further comprises transmitting an emergency signal, via the communication link, upon activation of an emergency assistance button (SOS) included in the video display device.

Preferably, the method further comprises sounding an alarm upon activation of an alarm button included in the video display device.

Preferably, the method further comprises recording the reverse-video in a storage device included in the video capture device.

In another aspect, a method of providing a user interface for displaying reverse-video is disclosed wherein the user interface being accessible via a video display device and wherein the method comprises receiving the reverse-video, via a communication link included in the video display device, and displaying the reverse-video on a display screen included in the video display device, wherein the reverse-video is obtained by a wearable reverse-video capture and display system worn by a wearer moving in a first direction, the system comprising a magnetic holder removably secured to an object worn by the wearer, the holder having a coupling plane whose normal vector is in a second direction substantially opposite to the first direction, a video capture device including a ferrous base magnetically secured to the coupling plane of the holder, via magnetic flux, configured to capture the reverse-video of scenes in the second direction and transmit the reverse-video, via the communication link, and the video display device, configured to receive the reverse-video, via the communication link and display the reverse-video on the display screen included in the video display device, wherein the wearer views the scenes residing in the wearer's rear view on the video display device in real time.

Preferably, a non-transitory machine-readable storage medium provides instructions that, when executed by a processing system, causes the processing system to perform reverse-video display operations according to method of providing the user interface for displaying reverse-video.

### DESCRIPTION OF THE DRAWINGS

FIG. 1 shows a preferred embodiment of a wearable reverse-video capture and display system according to the present invention.

FIG. 1A shows a preferred embodiment of the video display device included in the wearable reverse-video capture and display system shown in FIG. 1.

FIG. 2 shows a preferred embodiment of a wearable reverse-video capture and display system according to the present invention.

FIG. 2A shows a preferred embodiment of the video display device included in the wearable reverse-video capture and display system shown in FIG. 2.

FIG. 3 shows an exploded view of a preferred embodiment of a video capture device and a magnetic holder included in a wearable reverse-video capture and display system according to the present invention.

FIG. 4 shows a cross-sectional exploded view of a preferred embodiment of a video capture device and a magnetic holder included in the wearable reverse-video capture and display system according to the present invention.

FIG. 4A shows the video capture device and the magnetic holder of FIG. 4 magnetically coupled together.

FIG. 5 shows an exploded view of a preferred embodiment of a video capture device and a magnetic holder included in the wearable reverse-video capture and display system according to the present invention.

FIG. 6 shows a cross-sectional view of a preferred embodiment of a video capture device and a magnetic holder included in the wearable reverse-video capture and display system according to the present invention.

### DETAILED DESCRIPTION OF THE PRESENTLY PREFERRED EMBODIMENTS

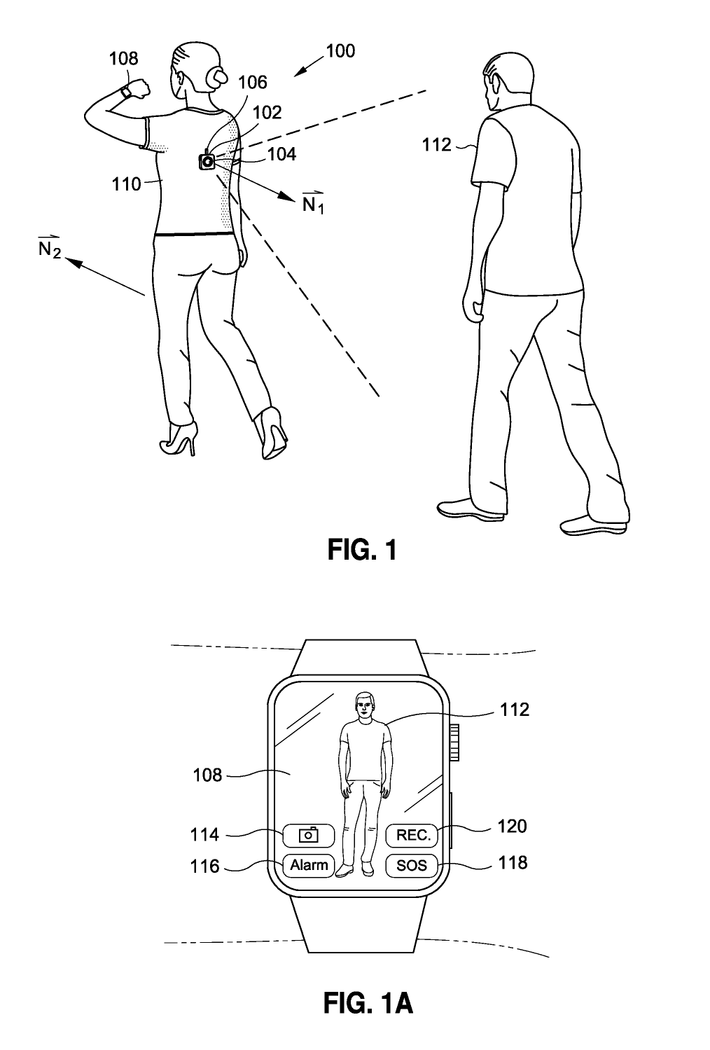

FIG. 1 depicts a diagram of a preferred embodiment of a system 100 that can be implemented to capture and display in real time reverse-video utilizing the wearable reverse-video capture and display system worn by a wearer 110 moving in a first direction defined by the vector N2. The system 100 comprises a magnetic holder 102 having a coupling plane whose normal vector N1 is in a second direction which is substantially opposite to the first direction. The holder 102 is removably secured to the wearer's garment via a fastener 106. The fastener 106 can be chosen from a variety of fasteners including but not limited to clasps, safety pins, and alligator clips which can easily and removably secure the holder 102 to the object worn by the wearer 110. The system 100 further comprises a video capture device 104 which has a ferrous base (shown in more detail in FIGS. 3 thru 6) which is magnetically secured to the coupling plane of the holder 102 via the magnetic flux generated by the permanent magnet of the magnetic holder 102. The video capture device 104 captures the reverse-video of scenes in the direction of the vector N2 which includes a person 112 walking in the same direction of the wearer 110. The video capture device 104 streams the reverse-video in real time via a transmitter (shown in more detail in FIG. 3) utilizing a communication link. In this preferred embodiment, the video capture device 104 is an IP camera which is commonly used for surveillance, and which, can send and receive data via a computer network and the Internet. In one instance, the video capture device 104 uses both Bluetooth and the Internet as the communication link to transmit data. The system 100 further comprises a video display device 108 which is worn by the wearer 110 on her wrist. The video display device 108 receives the streaming reverse-video in real time transmitted by the video capture device 104 via a receiver (not shown but know to artisans of ordinary skill) utilizing the communication link. The video display device 108 displays the scenes residing in the wearer 110's rear view on its display screen (shown in more detail in FIG. 1A) in real time. The system 100 can be worn by the wearer 110 for security purposes, in this case, monitoring the person 112 and his movements.

FIG. 1A depicts a diagram of a preferred embodiment of the video display device 108 included in the wearable reverse-video capture and display system shown in FIG. 1. In this preferred embodiment, the video display device 108 is a smartwatch such the Apple Watch manufactured by the Apple Company. The video display device 108 comprises a user interface, commonly referred to as an APP, having touch-screen buttons including a live video display button 114, a record video button 120, an alarm button 116, and an emergency assistance button (SOS) 118. The video display device 108 shows the person 112 on its display screen which the wearer 110 can see in real time. The wearer 110 can touch the button 120 to start recording the reverse-video in a storage device included in the video capture device 104 for future access which may be valuable to law enforcement. If the movements of the person 112 become suspicious, the wearer 110 can selectively touch the alarm button 116 or the SOS button 118, where the former sounds an alarm and the latter uses the Internet part of the communication link to transmit an emergency signal including time and GPS coordinates of the wearer 110.

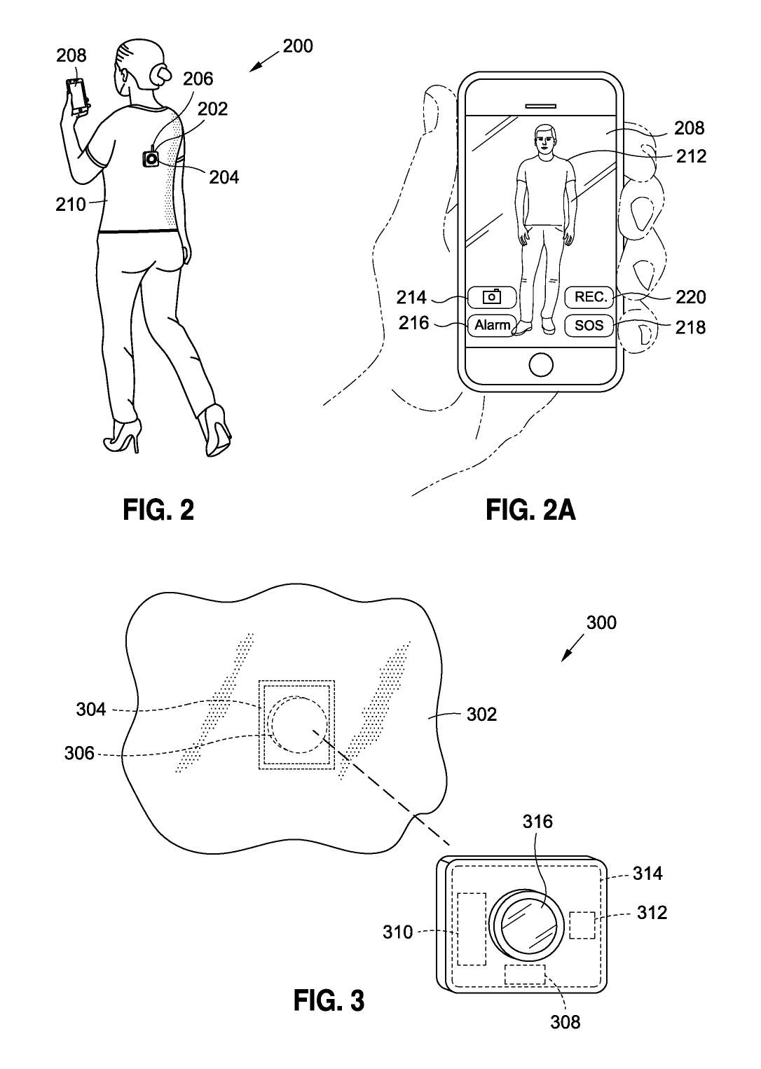

FIG. 2 depicts a diagram of a preferred embodiment of a system 200 that can be implemented to capture and display in real time reverse-video utilizing the wearable reverse-video capture and display system worn by a wearer 210 moving in a first direction defined by the vector N2, such as the vector N2 shown in FIG. 1. The system 200 comprises a magnetic holder 202 having a coupling plane whose normal vector N1 is in a second direction which is substantially opposite to the first direction. The holder 202 is removably secured to the wearer's garment via a fastener 206. The fastener 206 can be chosen from a variety of fasteners including but not limited to clasps, safety pins, and alligator clips which can easily and removably secure the holder 202 to the object worn by the wearer 210. The system 200 further comprises a video capture device 204 which has a ferrous base (shown in more detail in FIGS. 3 thru 6) which is magnetically secured to the coupling plane of the holder 202 via the magnetic flux generated by the permanent magnet of the magnetic holder 202. The video capture device 204 captures the reverse-video of scenes in the direction of the vector N2 which includes a person (not shown), such as the person 112 in FIG. 1 walking in the same direction as the wearer 210. The video capture device 204 streams the reverse-video in real time via a transmitter (shown in more detail in FIG. 3) utilizing a communication link. In this preferred embodiment, the video capture device 204 is an IP camera which comprises a night vision device (NVD) which is an optoelectronic device that allows images to be produced in levels of light approaching total darkness as described above. The video capture device 204 is commonly used for surveillance and can send and receive data via a computer network and the Internet. In one instance, the video capture device 204 uses both Bluetooth and the Internet as the communication link to transmit data. The system 200 further comprises a video display device 208 which is carried by the wearer 210 in her hand. The video display device 208 receives the streaming reverse-video in real time transmitted by the video capture device 204 via a receiver (not shown but know to artisans of ordinary skill) utilizing the communication link. The video display device 208 displays the scenes residing in the wearer 210's rear view on its display screen (shown in more detail in FIG. 2A) in real time. The system 200 can be worn by the wearer 210 for security purposes, in this case, monitoring a person 212 (shown in FIG. 2A) and his movements.

FIG. 2A depicts a diagram of a preferred embodiment of the video display device 208 included in the wearable reverse-video capture and display system shown in FIG. 2. In this preferred embodiment, the video display device 208 is a smartphone such the iPhone manufactured by the Apple Company. The video display device 208 comprises a user interface, such as the APP described above, having touch-screen buttons including a live video display button 214, a record video button 220, an alarm button 216, and an emergency assistance button (SOS) 218. The video display device 208 shows the person 212 on its display screen which the wearer 210 can see in real time. The wearer 210 can touch the button 220 to start recording the reverse-video in a storage device included in the video capture device 204, or alternatively in a storage device included in the video display device 208, for future access which may be valuable to law enforcement. If the movements of the person 212 become suspicious, the wearer 210 can selectively touch the alarm button 216 or the SOS button 218, where the former sounds an alarm and the latter uses the Internet part of the communication link to transmit an emergency signal including time and GPS coordinates of the wearer 210.

FIG. 3 depicts a diagram 300 of an exploded view of a preferred embodiment of a video capture device and a magnetic holder that can be implemented to capture and display in real time reverse-video utilizing the wearable reverse-video capture and display system worn by a wearer, such as the wearer 110 and 210 in FIGS. 1 and 2. In this preferred embodiment, a partial view of the garment 302 is shown where a magnetic holder 306, such as a circular piece of permanent magnet, is embedded in the garment 302 inside a pocket 304 which is stitched to the garment 302 around all its four sides. A video capture device 316 is shown having a ferrous base 314 which magnetically couples with the magnetic holder 306. The video capture device 316 comprises a microcontroller 310, such as the microcontroller utilized in the iPhone manufactured by the Apple Company including all its peripheral devices, a transceiver 308 having a communication link which includes Bluetooth, Wi-Fi, and the Internet, and a power source, such as a battery 312.

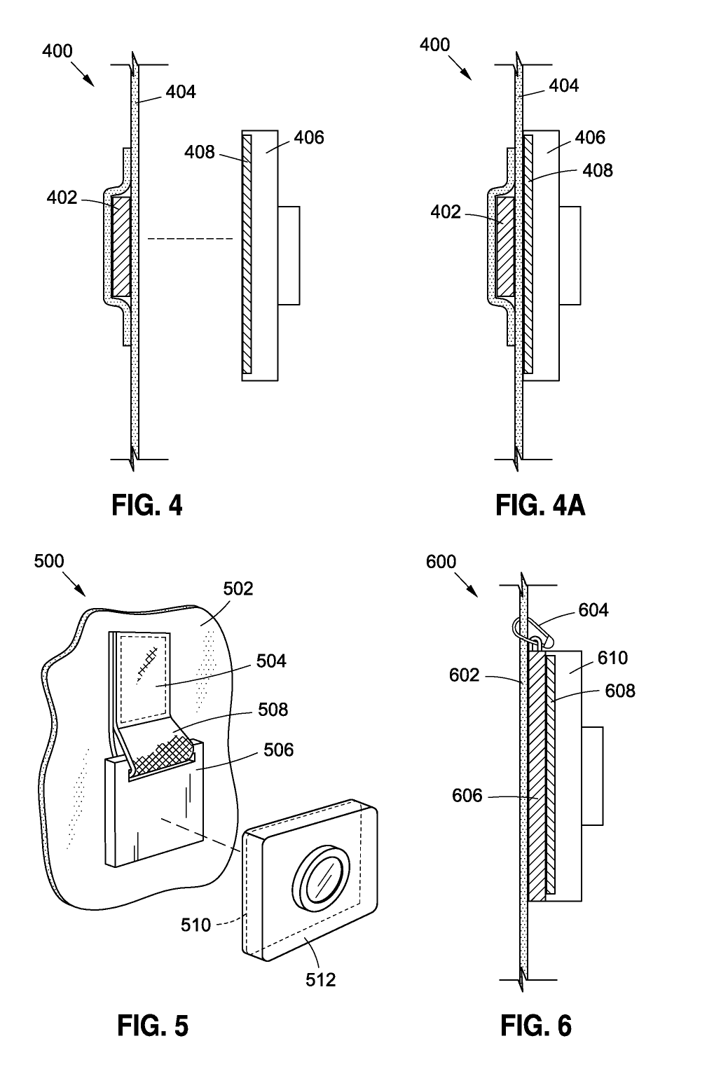

FIG. 4 depicts a diagram 400 of a cross-sectional exploded view of a preferred embodiment of a video capture device and a magnetic holder that can be implemented to capture and display in real time reverse-video utilizing the wearable reverse-video capture and display system worn by a wearer, such as the wearer 110 and 210 in FIGS. 1 and 2. In this preferred embodiment, a cross-sectional view of a garment 404 is shown where a magnetic holder 402, such as a circular piece of permanent magnet, is disposed on one side of the garment 404. A cross sectional view of a video capture device 406 having a ferrous base 408 is shown on the other side of the garment 404. FIG. 4A depicts the diagram 400 of the cross-sectional view of the video capture device 406 and the magnetic holder 402 magnetically coupled together. According to this preferred embodiment, the magnetic holder 402 and the video capture device 406 are held together via the magnetic flux between the permanent magnet and the ferrous base 408 to hold the assembly to the garment 404 without the need for a fastener.

FIG. 5 depicts a diagram 500 of an exploded view of a preferred embodiment of a video capture device and a magnetic holder that can be implemented to capture and display in real time reverse-video utilizing the wearable reverse-video capture and display system worn by a wearer, such as the wearer 110 and 210 in FIGS. 1 and 2. In this preferred embodiment, a partial view of a backpack 502 is shown where a magnetic holder 506, such as a rectangular piece of permanent magnet including a slot, is fastened to the backpack 502 via a piece of cloth 504, stitched to the backpack 502 which includes a loop 508 which can be opened and closed utilizing Velcro straps and operative to secure the magnetic holder 506 to the backpack 502. A video capture device 512 is shown having a ferrous base 510 which magnetically couples with the magnetic holder 506.

FIG. 6 depicts a diagram 600 of a cross-sectional view of a preferred embodiment of a video capture device and a magnetic holder that can be implemented to capture and display in real time reverse-video utilizing the wearable reverse-video capture and display system worn by a wearer, such as the wearer 110 and 210 in FIGS. 1 and 2. In this preferred embodiment, a cross-sectional view of a garment 602 is shown where a magnetic holder 602, such as a circular piece of permanent magnet, is disposed on one side of the garment 602 and is secured to the garment 602 via a safety pin 604. A cross sectional view of a video capture device 610 having a ferrous base 608 is shown on the same side of the garment 602 magnetically coupled with the holder 606.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A wearable reverse-video capture and display system worn by a wearer moving in a first direction, comprising:
(a) a magnetic holder removably secured to an object worn by the wearer, the holder having a coupling plane whose normal vector is in a second direction substantially opposite to the first direction;
(b) a video capture device including a ferrous base magnetically secured to the coupling plane of the holder, via magnetic flux, configured to capture the reverse-video of scenes in the second direction and transmit the reverse-video, via a communication link; and
(c) a video display device, configured to receive the reverse-video, via the communication link and display the reverse-video on a display screen included in the video display device;
wherein the wearer views the scenes residing in the wearer's rear view on the video display device in real time.

2. The system of claim 1, wherein the magnetic holder is disposed on a first side of the object and the video capture device is disposed on a second side of the object opposite to the first side.

3. The system of claim 1, wherein the object comprises a pocket and wherein the magnetic holder is disposed inside the pocket and on a first side of the pocket and the video capture device is disposed on a second side of the pocket opposite to the first side.

4. The system of claim 1, wherein the magnetic holder is embedded in the object.

5. The system of claim 1, wherein the object is one of a garment, eye glasses, and backpack.

6. The system of claim 1, wherein the magnetic holder comprises a fastener operative to fasten the magnetic holder to the object.

7. The system of claim 6, wherein the fastener is one of adhesive tape and an alligator clip.

8. The system of claim 1, wherein the video capture device further comprises a night vision device configured to capture the reverse-video of scenes in darkness.

9. The system of claim 1, wherein the video display device further comprises an emergency assistance button (SOS) and wherein the video display device is further configured to transmit an emergency signal, via the communication link, upon activation of the button.

10. The system of claim 1, wherein the video display device further comprises an alarm button and wherein the video display device is further configured to sound an alarm upon activation of the button.

11. The system of claim 1, wherein the video display device is one of a smartwatch and smartphone.

12. The system of claim 1, wherein the communication link comprises at least one of Bluetooth, WiFi, and the Internet.

13. The system of claim 1, wherein the video capture device is further configured to record the reverse-video in a storage device included in the video capture device.

14. A method of capturing and displaying reverse-video via a wearable reverse-video capture and display system worn by a wearer moving in a first direction, the method comprising:
(a) removably securing a magnetic holder to an object worn by the wearer, the holder having a coupling plane whose normal vector is in a second direction substantially opposite to the first direction;
(b) capturing the reverse-video of scenes in the second direction, via a video capture device including a ferrous base magnetically secured to the coupling plane of the holder, via magnetic flux;
(c) transmitting the reverse-video, via a communication link;
(d) receiving the reverse-video, via the communication link; and
(e) displaying the reverse-video on a display screen, via a video display device including the display screen;
wherein the wearer views the scenes residing in the wearer's rear view on the video display device in real time.

15. The method of claim 14, further comprising:
(f) transmitting an emergency signal, via the communication link, upon activation of an emergency assistance button (SOS) included in the video display device.

16. The method of claim 14, further comprising:
(f) sounding an alarm upon activation of an alarm button included in the video display device.

17. The method of claim 14, further comprising:
(f) recording the reverse-video in a storage device included in the video capture device.

18. The method of claim 14, wherein the object is one of a garment, eye glasses, and backpack.

19. A method of providing a user interface for displaying reverse-video, the user interface being accessible via a video display device, the method comprising:
(a) receiving the reverse-video, via a communication link included in the video display device; and
(b) displaying the reverse-video on a display screen included in the video display device;
wherein the reverse-video is obtained by a wearable reverse-video capture and display system worn by a wearer moving in a first direction, the system comprising:
(1) a magnetic holder removably secured to an object worn by the wearer, the holder having a coupling plane whose normal vector is in a second direction substantially opposite to the first direction;
(2) a video capture device including a ferrous base magnetically secured to the coupling plane of the holder, via magnetic flux, configured to capture the reverse-video of scenes in the second direction and transmit the reverse-video, via the communication link; and
(3) the video display device, configured to receive the reverse-video, via the communication link and display the reverse-video on the display screen included in the video display device;
wherein the wearer views the scenes residing in the wearer's rear view on the video display device in real time.

20. A non-transitory machine-readable storage medium, which provides instructions that, when executed by a processing system, causes the processing system to perform reverse-video display operations according to a method as in claim 19.
